(19) United States
(12) Patent Application Publication
(10) Pub. No.: US 2011/0311908 A1
(43) Pub. Date: Dec. 22, 2011

(54) METHOD AND DEVICE FOR THE PRODUCTION OF A FILM

(76) Inventor: Detlef Schulze-Hagenest, Molfsee (DE)

(21) Appl. No.: 13/133,406

(22) PCT Filed: Nov. 30, 2009
(86) PCT No.: PCT/EP2009/066076

§ 371 Date: Sep. 8, 2011

(30) Foreign Application Priority Data
Dec. 30, 2008 (DE) 10 2008 063 319.4

(51) Int. Cl. G03G 13/20; G03G 13/06; G03G 13/01; G03G 15/20

(52) U.S. Cl. 430/97; 399/335; 399/336; 399/329

(57) ABSTRACT

The invention relates to a method and a device that permit the production of an optionally multi-colored film in a simple and cost-effective manner. In this method for the production of a film, toner is first applied to a transport belt with the use of at least one printing unit in such a manner that an essentially uninterrupted toner layer is formed on the transport belt. The toner on the transport belt is then heated with at least one first heat source to a temperature above a melting point of the toner and is subsequently cooled to below the melting point of the toner. Finally, the toner is removed from the transport belt as a cohesive material layer. The device comprises a transport belt, at least one printing unit arranged for applying a toner to the transport belt, and at least one heat source. Viewed in a direction of movement of the transport belt, the heat source is arranged downstream of the at least one printing unit in such a manner that said heat source is able to heat the toner present on the transport belt and that said heat source is suitable to heat the toner to a temperature above a melting point of said toner.

### TECHNICAL FIELD OF THE INVENTION

The present invention relates to a method and a device for the production of a film.

### BACKGROUND ART OF THE INVENTION

The most diverse methods for the production of films are known in the art, of which extrusion and calendaring represent conventional processes.

As a rule, these methods only allow the production of monochrome and transparent films. In order to produce multi-color films or films with images or text, these films must be printed after an original film production step, which is very complex and frequently leads to adhesion problems. Furthermore, as a rule, this is only possible with special films that tolerate temperatures that are usually used for fusing toner particles that have been applied.

Based on conventional methods and devices for the production of films, the object of the present invention is thus to provide a method and a device that permit the production of an optionally multi-colored film in a simple and cost-effective manner.

### SUMMARY OF THE INVENTION

In accordance with the invention, this object is achieved with a method in accordance with claim 1 and a device in accordance with claim 19. Additional embodiments of the invention are obvious from the subclaims.

In particular, a method for the production of a film is provided, wherein a toner is applied to a transport belt with the use of at least one printing unit in such a manner that an essentially uninterrupted toner layer is formed on the transport belt. The toner on the transport belt is then heated with the use of at least one first heat source to a temperature above a melting point of the toner and is subsequently cooled to below the melting point of the toner, and is removed from the transport belt as a cohesive material layer. With the use of the above method, it is made possible in a simple manner to directly produce a film of toner, this permitting, in particular, multi-color and, if so desired, full-color image films. In the present case, the phrasing “an essentially uninterrupted toner layer” means a toner layer with toner particles that are in contact with each other and that run together upon heating the toner to above a melting point of said toner and thus form a cohesive material layer, although it is also possible to provide openings in specific locations. In particular, it is possible to provide specifically placed openings in the toner layer in order to reproduce any kind of shapes, without necessitating any trimming thereof. The method permits a simple and cost-effective way of producing a continuous film web or also of producing sheet-type film sections that do not require trimming. Sheet-type films are produced, for example, by applying toner in the form of the film, while an appropriate free space is left relative to the subsequent film.

In accordance with a preferred embodiment of the invention, the polymer chains of the toner are cross-linked while the toner is melted in order to additionally increase the stability of the film. To do so, a thermally cross-linked toner is kept at least for one second at a temperature above the melting point of the toner and, preferably, for a period of 1 to 10 seconds at a temperature above the melting point of the toner. Alternatively or additionally, it is possible, for example, to apply UV radiation to a UV-cross-linking toner, while said toner has a temperature above the melting point of the toner.

Preferably, at least a second heat source is provided in order to maintain the temperature of the toner for a prespecified time above the melting point of the toner. Preferably, the toner is heated with a heat source that is not in contact with the toner and/or is kept at a temperature above the melting point. For very rapid contactless heating, it is possible to provide, in particular, a microwave applicator as a heat source. In order to maintain the temperature of the toner, it is possible to provide, in particular, an IR radiation source as the second heat source. It is also possible to provide an essentially closed oven chamber as a heat source, where the transport belt with the applied toner is moved through said oven chamber. Alternatively, it is also conceivable to use a heat source that directs hot air at the toner.

In one embodiment of the invention, the toner, while being cooled, is sandwiched between the transport belt on one side and a circulating belt opposite the transport belt. Such sandwiching between two belts permits a film formation with defined surface structures. Preferably, the toner is also sandwiched between the transport belt on one side and the belt on the other side, while being heated.

In accordance with a particularly preferred embodiment of the invention, a plurality of printing units apply different toners to the transport belt, thus permitting a multi-color film that is, if desired, provided with a pattern or also with any image. To do so, it is preferable that toner having different colors be applied. Preferably, at least one colorless toner is applied in such a manner that an essentially uninterrupted toner layer of colorless toner is formed, that, for example, may act as a continuous support or bonding layer. Different-color toners may then be used as desired, for example, to create images and structures. Preferably, the colorless toner has an average particle size that is greater than that of other toners that are being used in order to provide a sufficiently stable, fused toner layer after melt-depositing the toner particles.

In a preferred embodiment of the invention, toner is applied to the transport belt by means of an electrophotographic method.

The object of the invention is also achieved by a device for the production of a film, said device comprising a transport belt, at least one printing unit arranged on the transport belt for the application of a toner, and at least one heat source that, viewed in a direction of movement of the transport belt, is arranged downstream of the at least one printing unit in such a manner that said heat source is able to heat toner present on the transport belt. The heat source is suitable to heat the toner to a temperature above a melting point of said toner. Such a device permits a direct production of a film of toner in accordance with the previously described method and thus also offers the same advantages.

Preferably, at least one cooling unit is provided, said cooling unit, viewed in a direction of movement of the transport belt, being arranged downstream of the at least one heat source in such a manner that said cooling unit can cool the toner present on the transport belt, the cooling unit being suitable to cool the toner to a temperature below the melting point of the toner. Preferably, at least one control unit for controlling a transport speed of the transport belt and/or the heat source is provided in order to ensure proper melt-depositing of the toner. In one embodiment, at least one UV radiation source is provided in such a manner that said UV radiation source directs UV radiation at the transport belt within the range of the at least one heat source so that a UV-cross-linking of the toner in fused state is possible.

It is also possible to provide a second heat source that, viewed in a direction of movement of the transport belt, is arranged downstream of the at least one first heat source and that is suitable to maintain the toner at a temperature above the melting point of the toner. The second heat source, in particular with a thermally cross-linking toner, permits that said toner can be maintained above the melting temperature over an extended period of time. Preferably, at least one heat source is suitable to heat the toner in a contactless manner so as not to impair the toner structure and thus an image or a pattern formed thereby. Suitable heat sources are, in particular, a microwave applicator, an IR radiation source, a radiation source with an IR component and a UV component, where both the IR component and the UV component are at least 20%, an essentially closed oven chamber and/or a source of hot air. Alternatively, it is also possible to provide, as the heat source, two rollers that are biased against each other, at least one of said rollers being heatable via a corresponding heating device, the transport belt being passed through a nip between the rollers. In printing technology, such rollers have been known for fusing images to a support substrate.

In accordance with one embodiment of the invention, a circulating belt is provided, said belt contacting the transport belt along a region that covers at least an effective region of the at least one heat source and the at least one cooling unit. As mentioned above, such an additional circulating belt permits the formation of defined surface structures on the film. If the first heat source has the two oppositely arranged rollers, one of the rollers is preferably a deflecting roller for the circulating belt.

Advantageously, the circulating belt and/or the transport belt are designed as glosser belts in order to be able to produce a high-gloss film. A glosser belt is a belt displaying very minimal surface roughness as is known in printing technology. Preferably, the circulating belt and/or the transport belt consist of an anti-adhesive material or are coated with such a material in order to permit a good detachment of the film. To accomplish this, the circulating belt and/or the transport belt consist, for example, of a polyimide material or are coated with such a material.

In order to produce a continuous web of film displaying as few flaws as possible, the circulating belt and/or the transport belt preferably consist of a seamless web material. Alternatively, the circulating belt and/or the transport belt could have an essentially plane exterior surface so that, even if a seam were formed, said seam would not be imaged. In order to permit a direct irradiation of the toner on the transport belt, the circulating belt and/or the transport belt consist of a transparent material in one embodiment of the invention.

A particularly preferred embodiment of the invention provides for a plurality of printing units for the application of different toners on the transport belt in order to be able to produce, for example, multi-color images, in particular full-color images or structures with patterns. In this embodiment, preferably at least one printing unit is capable of providing an essentially uninterrupted toner cover on the transport belt, said toner cover acting, for example, as the cohesive support or bonding layer. Preferably, at least one printing unit is an electrophotographic printing unit.

Another embodiment of the invention provides for at least one cleaning device for cleaning the transport belt and/or the circulating belt.

### BRIEF DESCRIPTION OF THE DRAWINGS

Hereinafter, the invention will be explained in detail with reference to the drawings.

FIG. 1 is a schematic side view of a device for the production of a film; and

FIG. 2 is a schematic side view of an alternative device for the production of a film.

### DETAILED DESCRIPTION OF THE INVENTION

In the description hereinafter, the information regarding position and/or direction relates to the depiction in the drawings and is not intended to restrict the application in any way.

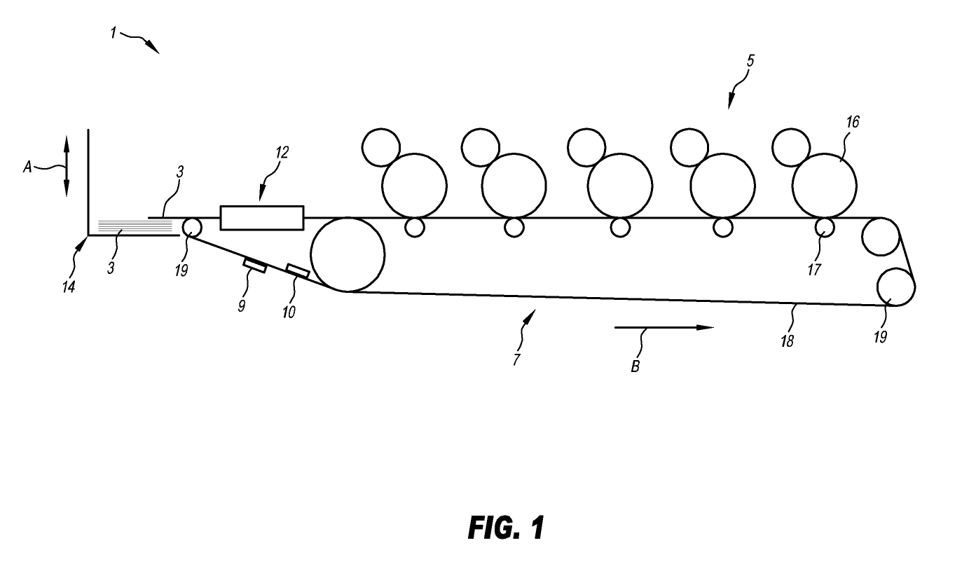

FIG. 1 is a schematic side view of a device 1 for the production of films 3. The device 1 comprises a plurality of printing units 5, a transport unit 7, a cleaning unit 9, a cooling unit 10, a fusing unit 12 and a tray 14.

In accordance with FIG. 1, the films 3 are shown in the form of sheets and are placed as a film sheet stack on the tray 14, said tray being height-adjustable as is indicated by the double arrow A. As will still be explained in detail hereinafter, it is also possible, however, to produce a continuous film with the device 1, which continuous film can then be taken up on a roll, for example.

The depicted device 1 shows five printing units 5 that, for example, can be operated with the colors black, cyan, magenta, yellow and a clear toner. As is obvious to a person skilled in the art, it is possible, of course, to also provide another number of printing units operating with different colors.

The printing units 5 are shown as electrophotographic printing units, each comprising an imaging cylinder 16 that, as depicted, is in direct contact with the transport unit 7. Of course, an intermediate cylinder between the imaging cylinder 16 and the transport unit 7 may also be provided. Each of the imaging cylinders 16 is arranged above the transport unit 7 and is driven by said transport unit in the direction of rotation, as will still be explained in detail hereinafter. Each of the imaging cylinders 16 is associated with oppositely arranged pressure rollers 17. Numerous such printing units 5 have been known in the art and will thus not be explained in detail.

The transport unit 7 essentially consists of a transport belt 18 that is guided around appropriate guiding and/or driving rollers 19 in order to provide a closed path of movement. The transport belt 18 passes through a nip between an imaging cylinder 16 and an associated pressure roller 17 of the respective printing units 5. The transport belt 18 is in direct frictional engagement with the imaging cylinder 16 and the pressure roller 17 and thus rotates them when the transport belt is being rotated. If an intermediate cylinder were provided, this cylinder would be in frictional engagement with the transport belt 18 as well as with the imaging cylinder 16, so that said cylinder would still be indirectly driven by the transport belt 18.

Preferably, the transport belt 18 consists of an anti-adhesive material or is coated with such a material. An obvious such material is a polyimide material, for example. The transport belt 18 preferably consists of a seamless belt material or has at least an essentially plane exterior surface, if a seam is provided. Furthermore, the transport belt should consist of a material that is not impaired by the temperatures inside the fusing unit 12 and should also be transparent. The outward-facing surface of the transport belt 18 is configured as a so-called glosser belt, i.e., a belt displaying low surface roughness—as is known in printing technology—in order to provide a high gloss in toner images.

Although not illustrated, rotary encoders may be provided on the respective imaging cylinders 16 and on at least one of the transport and/or guiding cylinders 19 in order to detect the respective rotary positions of the elements. This permits, in a known manner, a register-perfect print of different color separation images by the printing units 5. For this purpose and for the purpose of calibration, the device 1 may also comprise a not shown register sensor as is common in electrophotographic printing machines and has been described, for example, in the not pre-published DE 10 2008 052 397 that goes back to the applicant.

The cleaning unit 9 is arranged, viewed in a circulating direction of the transport belt 18 (see arrow B), downstream of the printing units 5 and of the fusing unit 12. The cleaning unit 9 comprises suitable means for cleaning the transport belt 18, for example, rotating brushes and/or stationary strippers.

The cooling unit 10, viewed in circulating direction of the transport belt 18, is again arranged downstream of the cleaning unit 9 and upstream of the printing units 5. The cooling unit 10 may direct cool air, for example, against an interior or exterior surface of the transport belt 18 in order to bring said belt to a prespecified temperature.

The fusing unit 12 is arranged between the printing units 5 and the cleaning unit 9. The fusing unit 12 is also arranged in such a manner that the transport belt 18 extends through said fusing unit. At least one heat source is provided inside the fusing unit 12, said heat source being capable of heating a toner on the transport belt 18 to a temperature above the melting temperature of the toner. Even though it is not absolutely necessary, this heat source is preferably a heat source that is able to heat the toner in a contactless manner, for example, by means of a microwave source, an IR radiation source, a source of hot air, an essentially closed oven chamber with appropriate heating elements, etc. Depending on the toner that is used, it is also possible to provide a UV radiation source inside the fusing unit 12, said UV radiation source being arranged in such a manner that it can direct UV radiation in the direction of the transport belt 18 and a toner applied thereon. To accomplish this, a radiation source could be provided that has a UV component in addition to an IR component, where both the IR component and the UV component should be at least 20%.

Of course, it is also possible to provide a heat source that contacts the transport belt 18, said heat source comprising two rollers acting against each other, for example, at least one of said rollers being heated. Such fusing rollers are known in printing technology. Preferably, a second, not specifically illustrated heat source is provided inside the fusing unit, said heat source being arranged in such a manner that it can maintain a toner present on the transport belt 18 above the melting point of the toner for an extended period of time of preferably 1 to 10 seconds or even longer. The second heat source may be of the same type as or of a different type than the first heat source, however, as a rule, need not couple in as much energy as the first heat source because only the maintenance of a specific temperature is necessary and not a heating beyond the temperature of the melting point.

Inside the fusing device 12 or, viewed in circulating direction of the transport belt 18, an additional not specifically illustrated cooling unit may be provided in order to cool a toner present on the transport belt 18 in an end region of the fusing unit 12, or farther downstream, to a temperature below the melting point of the toner.

Hereinafter, the operation of the device 1 will be explained in greater detail.

First, the transport belt 18 is operated in circulating direction B. The four printing units 5 that are upstream—viewed in circulating direction B of the transport belt 18—are then used to print, for example, register-perfect different color separation images of each toner image on the transport belt 18, from which a varied and, if desired, incomplete toner coverage on the transport belt 18 may result. The last printing unit 5, viewed in circulating direction B of the transport belt 18, then applies a clear toner to the transport belt 18 in such a manner that an essentially uninterrupted toner layer is formed on the transport belt 18. Here, “essentially uninterrupted” is meant to describe a situation in which adjacent toner particles are in contact with each other so that they form a cohesive layer when they are fused. However, “essentially uninterrupted” is also meant to include a situation in which free spaces are specifically provided within a printing image, or between adjacent printing images, in order to produce specific shapes. In FIG. 1, that is to show the production of sheet-type films 3, it is possible to produce printing images that are at a distance from each other, as would be common in sheet printing. In such a case it is also not necessary for the transport belt to be seamless because the transport belt 18 could be printed in such a manner that a region around the seam of the transport belt 18 will we excluded from printing. If, however, for example, a continuous film is to be printed, this being accomplished by a continuous application of toner by the printing units 5, it would be of advantage if the transport belt 18 did not have a seam, because said seam could potentially be imaged inside the film.

After the toner has been applied to the transport belt 18 in the above manner, the transport belt 18 with the toner present on it moves through the fusing unit 12. Inside the fusing unit 12, at least the first heat source brings the toner to a temperature above the melting point of the toner, and then a second heat source maintains the temperature above the melting point for a prespecified time, for example 1 to 10 seconds. During this process, the individual toner particles will melt and form a cohesive toner layer that, upon cooling to below the melting point of the toner, can be removed as a cohesive layer in the form of the film 3 from the transport belt 18. When a thermally cross-linking toner is used, a cross-linking reaction of the polymer chains of the toner occurs, thus increasing the stability of the film 3. If the toner contains UV-cross-linking elements, UV radiation is preferably applied to the toner inside the fusing unit 12 in order to provide additional cross-linking and thus increased stability of the film 3. In this case, the UV radiation is introduced into the toner while it is heated to a temperature above its melting point.

Subsequently, the toner is actively or passively cooled inside the fusing unit or downstream thereof to the temperature below the melting point of said toner in order to be subsequently removed as the film 3 from the transport belt 18. An active cooling of the toner is preferred; however, it is also possible to provide a passive cooling over an appropriate transport distance covered by the transport belt 18. For active cooling, it is possible, for example, to direct cool air to an upper side of the toner layer and/or a rear side of the transport belt 18. Of course, other cooling mechanisms are also conceivable. For example, the transport belt 18 may move over one or more cooled rollers, or it is also possible to provide one or more cooled rollers that are in direct contact with the toner. As is obvious to the person skilled in the art, the most diverse possibilities of cooling the toner to a temperature below its melting point exist here in order to be able to subsequently remove the toner as the film 3 from the transport belt 18.

As is further obvious to the person skilled in the art, the above-described method permits the production of a toner film without support material, i.e., the film consists only of toner particles. Furthermore, the above method permits the production of films with any coloration, even with full-color images and in any form.

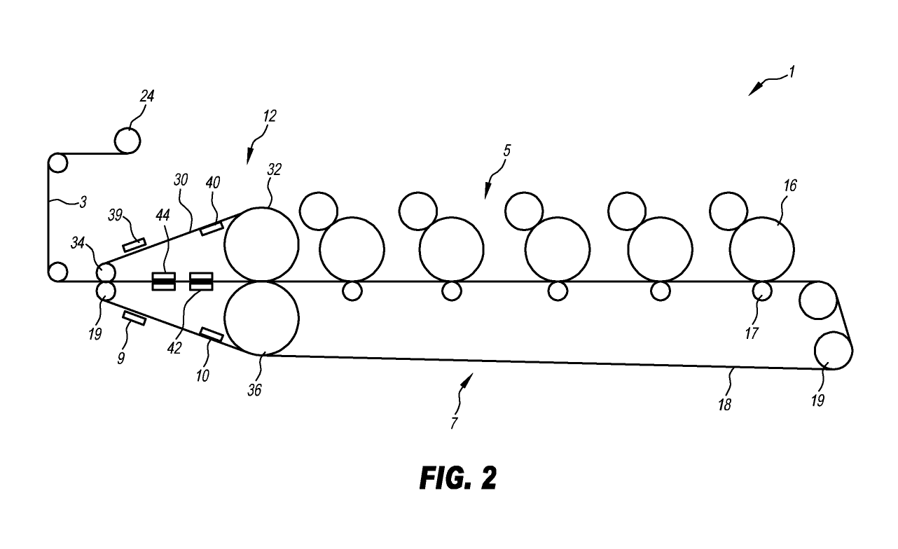

FIG. 2 is a schematic side view of an alternative device 1 that shows the production of a continuous film 3. In the illustration in accordance with FIG. 2, the same reference signs are used if the same or similar elements are provided.

The device 1 again comprises a plurality of printing units 5, a transport unit 7, a cleaning unit 9, a cooling unit 10 and a fusing unit 12. Instead of a height-adjustable tray 14, FIG. 2 uses a take-up roller 24 for a continuous film 3. Of course, it would also be possible to again provide a height-adjustable tray 14 if the device 1 were intended for the production of sheet-type films 3.

Again, five printing units 5 are shown that, again, are of the electrophotographic type with an imaging cylinder 16. Said printing units are again associated with pressure rollers 17.

Also, the transport unit 7 is essentially constructed in a manner identical to the previously described transport unit comprising a transport belt 18 that is guided in a circulating manner through a plurality of guiding and/or driving rollers 19. Again, the transport belt 18 extends through corresponding nips between the imaging cylinders 16 of the respective printing units 15 and the associate pressure rollers 17. In particular in this embodiment, the transport belt is a seamless transport belt 18, for example, of a polyimide material. Alternatively, the seam may also be flat enough that it is not or hardly formed within the film 3. However, a seam could also mark a cutting edge for cutting the film 3 to size within said seam in order to permit, for example, cutting the film 3 corresponding to the length of the transport belt 18. A circulating belt 30 is provided in the region of the fusing unit 12, said belt being in contact with one exterior side of the transport belt 18. If toner is present on the transport belt 18, said toner is sandwiched between the transport belt 18 and belt 30 in the region of the fusing unit 12.

The belt 30 is guided so as to circulate around a first roller 32 and a second roller 34, preferably, at least one of the rollers 32, 34 driving the transport belt 30 in a circulating manner at the speed of the transport belt 18.

Alternatively, the transport belt 30 could also be taken along by frictional engagement with the transport belt 18. The belt 30 is a seamless belt that—as the glosser belt—displays low surface roughness. In particular, it may consist of the same material as the transport belt 18. The roller 32 is preferably a heated roller that pushes against a roller 36 located underneath, which may be part of the transport unit 7. One of the rollers 32, 36 may be heated in order to rapidly heat a toner present on the transport belt 18 by means of the temperature of the roller, and optionally via a pressure between the rollers, to a temperature above the melting temperature of the toner. In contrast, one of the rollers 19 or 34 may be configured as a cooling roller, for example, in order to cool the toner present on the transport belt 18 to a temperature below the melting point of said toner.

Furthermore, a cleaning unit 39 and a cooling unit 40 are provided in the region of the transport belt 30, these corresponding to the cleaning unit 9 and the cooling unit 10 for the transport belt 18. Furthermore, in the region in which the transport belt 18 and the belt 30 are in contact with each other, a heat source 42 is provided, said heat source being of a type as has been described above. The heat source is capable of heating a toner accommodated between the transport belt 18 and the belt 30 to a temperature above the melting point of said toner or of maintaining said temperature over a specific period of time. To accomplish this, the heat source 42 may be of any suitable type. Furthermore, in the region in which the transport belt 18 and the belt 30 are in contact with each other, a cooling unit 44 is provided which, for example, directs cooling air at the respective belts in order to cool a toner layer present between them, in particular to a temperature below the melting point of said toner layer.

The operation of the device 1 in accordance with FIG. 2 is essentially the same as previously described, however, with the printing units 5 forming essentially a continuous layer of toner material on the circulating transport belt 18. Subsequently, this continuous layer is melt-deposited inside the fusing unit 12 and, if applicable, cross-linked by a cross-linking reaction. With the use of the cooling unit 44, the toner inside the fusing unit 12 is cooled to a temperature below the melting point of the toner in order to move the thusly produced cohesive toner layer in the form of a continuous film out of the region of the fusing unit 12 and to be taken up by the take-up roller 24.

As described above, the present invention permits the production of a film directly from the toner without support material. Although the invention has been described with reference to preferred embodiments of said invention, said invention is not restricted to the specifically illustrated embodiments. In particular, it is possible to combine or interchange different elements of the different embodiments with each other. In particular, the number of printing units used may, of course, be different from the illustrated number. It is only important that the printing units 5 be capable of producing—at least together, or also individually—an essentially uninterrupted toner layer. Preferably, at least one printing unit should be capable of producing an essentially complete toner layer, for example, with clear toner.

1. Method for the production of a film, said method comprising the following steps:
applying toner to a transport belt with the use of at least one printing unit in such a manner that an essentially uninterrupted toner layer is formed on the transport belt;
heating the toner on the transport belt with at least a first heat source to a temperature above a melting point of the toner;
cooling the toner to below the melting point of the toner; and
removing the toner as a cohesive layer of material from the transport belt.

2. Method as in claim 1, whereby effecting a cross-linking reaction of polymer chains of the toner while the toner is melted.

3. Method as in claim 1, wherein the toner is maintained for a period of time of at least 1 second at a temperature above the melting point of the toner.

4. Method as in claim 3, wherein the toner is maintained for a period of time of 1 to 10 seconds at a temperature above the melting point of the toner.

5. Method as in claim 1, UV radiation is applied to the toner while said toner has a temperature above the melting point of the toner.

6. Method as in claim 3, that the toner is maintained at a temperature above the melting point by at least a second heat source.

7. Method as in claim 1, wherein the toner is heated and/or is maintained at a temperature above the melting point with a heat source that is not in contact with the toner.

8. Method as in claim 1, wherein at least one heat source, in particular the first heat source, comprises a microwave applicator.

9. Method as in claim 1, wherein at least one heat source, in particular the second heat source, comprises an IR radiation source.

10. Method as in claim 1, wherein at least one heat source, in particular the second heat source, comprises an essentially closed oven chamber.

11. Method as in claim 1, wherein at least one heat source, in particular the second heat source, comprises a source of hot air.

12. Method as in claim 1, wherein the toner, at least while being cooled, is sandwiched between the transport belt on one side and a circulating belt opposite the transport belt.

13. Method as in claim 12, wherein the toner, while being heated, is also sandwiched between the transport belt on one side and the circulating belt.

14. Method as in claim 1, wherein a plurality of printing units apply different toners.

15. Method as in claim 1, wherein toner is applied in different colors.

16. Method as in claim 1, wherein at least one colorless toner is applied in such a manner that an essentially uninterrupted toner layer of colorless toner is formed.

17. Method as in claim 16, wherein the colorless toner has an average particle size that is greater than that of other toners that are being used.

18. Method as in claim 1, wherein toner is applied on the transport belt by an electrophotographic printing unit.

19. Device for the production of a film, comprising:
at least one printing unit that is arranged for applying a toner to the transport belt; and
at least a first heat source that, viewed in a direction of movement of the transport belt, is arranged downstream of the at least one printing unit in such a manner that said heat source is able to heat the toner present on the transport belt, the heat source being suitable to heat the toner to a temperature above the melting point of said toner.

20. Device as in claim 19, whereby at least one cooling unit that, viewed in a direction of movement of the transport belt, is arranged downstream of the at least one heat source in such a manner that said cooling unit is able to cool the toner present on the transport belt, the cooling unit being suitable to cool the toner to a temperature below the melting point of the toner.

21. Device as in claim 19, whereby at least one control unit for controlling a transport speed of the transport belt and/or the heat source.

22. Device as in claim 19, whereby at least one UV radiation source that is arranged in such a manner that it directs UV radiation at the transport belt in the region of the at least one heat source.

23. Device as in claim 19, wherein at least a second heat source is provided, said heat source being arranged, viewed in a direction of movement of the transport belt, downstream of the at least one first heat source and being suitable to maintain the toner at a temperature above the melting point of the toner.

24. Device as in claim 19, wherein at least one heat source is suitable to heat the toner in a contactless manner.

25. Device as in claim 19, wherein at least one heat source, in particular the first heat source, comprises a microwave applicator.

26. Device as in claim 19, wherein at least one heat source, in particular the second heat source, comprises an IR radiation source.

27. Device as in claim 19, wherein at least one heat source comprises a radiation source that has an IR component and a UV component, where both the IR and the UV component are at least 20%.

28. Device as in claim 19, wherein at least one heat source, in particular the second heat source, comprises an essentially closed oven chamber.

29. Device as in claim 19, wherein at least one heat source, in particular the second heat source, comprises a source of hot air.

30. Device as in claim 19, wherein the first heat source comprises two rollers that are biased against each other, at least one of said rollers being heatable via a corresponding heating device and the transport belt being passed through a nip between the rollers.

31. Device as in claim 19, whereby a circulating belt contacting the transport belt along a region that covers at least an effective region of the at least one heat source and the at least one cooling unit.

32. Device as in claim 28, wherein at least one roller is a deflecting roller for the circulating belt.

33. Device as in claim 19, wherein the circulating belt and/or the transport belt are configured as glosser belts.

34. Device as in claim 19, wherein the circulating belt and/or the transport belt consist of an anti-adhesive material or are coated with such a material

35. Device as in claim 19, wherein the circulating belt and/or the transport belt consist of a polyimide material or are coated with such a material.

36. Device as in claim 19, wherein the circulating belt and/or the transport belt consist of a seamless belt material.

37. Device as in claim 19, wherein the circulating belt and/or the transport belt each have an essentially plane exterior surface.

38. Device as in claim 19, wherein the circulating belt and/or the transport belt consist of a transparent material.

39. Device as in claim 19, wherein a plurality of printing units are provided for the application of different toners to the transport belt.

40. Device as in claim 19, wherein at least one printing unit is capable of providing an essentially uninterrupted toner cover on the transport belt.

41. Device as in claim 19, wherein at least one printing unit is an electrophotographic printing unit.
